(19) United States
(12) Patent Application Publication
(10) Pub. No.: US 2003/0229378 A1
(43) Pub. Date: Dec. 11, 2003

(54) Spinal support for reclining persons

(76) Inventor: Ida Weber, Sherwood Park (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/453,250

(22) Filed: Jun. 2, 2003

(30) Foreign Application Priority Data
Jun. 6, 2002 (CA) 2,389,469

(51) Int. Cl. A61G 7/07

(52) U.S. Cl. 606/237; 128/845; 606/240; 5/632; 5/657

(57) ABSTRACT

A spinal support for reclining persons includes a girdle adapted to encircle a waist of a person. The girdle has a right side lumbar support with a symmetrical body adapted to prevent sagging of a lumbar spine of a wearer when lying on his or her right side and a left side lumbar support with a symmetrical body adapted to prevent sagging of the lumbar spine of the wearer when lying on his or her left side. The left side lumbar support is positioned in opposed relation to the right side lumbar support with an unpadded connective webbing extending between the right side lumbar support and the left side lumbar support.

### FIELD OF THE INVENTION

The present invention relates to a spinal support for reclining persons and, more particularly, a spinal support suitable for use by persons experiencing low back pain, when sleeping, due to an unstable mid-lumbar spine.

### BACKGROUND OF THE INVENTION

Low back pain is one of the most common ailments affecting North American society. Certain conditions of the low back are aggravated by lifting, bending, or twisting movements of the trunk. Other conditions are aggravated by staying in one position for too long. These later conditions are usually ones of excessive movement of spinal segments affecting the stability of the spine. When a person with such a condition remains in one position, it allows an excessively mobile spinal segment to go beyond its anatomical barrier evoking structural injury or inflammation, with accompanying pain. When a person is sleeping, it may require a very painful stimulus to wake the person up, at which point it might be too late; as structural injury or inflammation will have already become well established. Control of the position of the spine during sleep is, therefore, of the utmost importance.

U.S. Pat. No. 5,338,289 (Cooker 1994) discloses a spinal support for reclining persons. The Cooker support has a support portion and a belt portion which joins the ends of the support portion. The two portions combine to encircle the waist of the user, with the support portion covering the majority of the waist's circumference. The Cooker support is suited for persons with hips that are substantially larger than their waist. Due to anatomical differences between men and women, the majority of persons who fit this description are women. Wider hips in comparison to the waist tends to leave the lumbar spine bent sideways, with the convex side bending downwardly by force of gravity towards the bed. This produces a continuous strain on the spine, especially at the L3-4 and L4-5 levels. The Cooker support fills in that portion of the waist, thereby reducing or eliminating the curvature of the spine.

Women who have large hips also tend to have a greater than average “lordosis”, which is a concavity in the curvature of the lumbar spine. This increased lordosis is symptom provoking in itself. In the case of a back sleeper, the Cooker support would force an increased lordotic angle, because of the padding pressing upwards against the mid-lumbar spine. This would tend to exacerbate the problem.

### SUMMARY OF THE INVENTION

What is required is a spinal support for reclining persons having an unstable mid-lumbar spine.

According to the present invention there is provided a spinal support for reclining persons which includes a girdle adapted to encircle a waist of a person. The girdle has a right side lumbar support with a symmetrical body adapted to prevent sagging of a lumbar spine of a wearer when lying on his or her right side and a left side lumbar support with a symmetrical body adapted to prevent sagging of the lumbar spine of the wearer when lying on his or her left side. The left side lumbar support is positioned in opposed relation to the right side lumbar support with an unpadded connective webbing extending between the right side lumbar support and the left side lumbar support.

The above described spinal support provides right side and left side support. As the wearer changes position during the night from sleeping on ones side to sleeping on ones back, the present spinal support does not force an increase in the lordotic angle of the wearer lying on their back.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a spinal support constructed in accordance with the teachings of the present invention.

FIG. 2 is a top plan view of the spinal support illustrated in FIG. 1, when laid flat.

FIG. 3 is a side elevation view, in section, of a person laying on their side without any spinal support.

FIG. 4 is a side elevation view, in section, of a person laying on their side wearing the spinal support illustrated in FIG. 1.

FIG. 5 labelled as “PRIOR ART” is a side elevation view of a person laying on their back with a spinal support constructed in accordance with the teachings of Cooker.

FIG. 6 is a side elevation view, in section, of a person laying on their back wearing the spinal support illustrated in FIG. 1.

### DETAILED DESCRIPTION OF THE PREFERRED EMBODIMENT

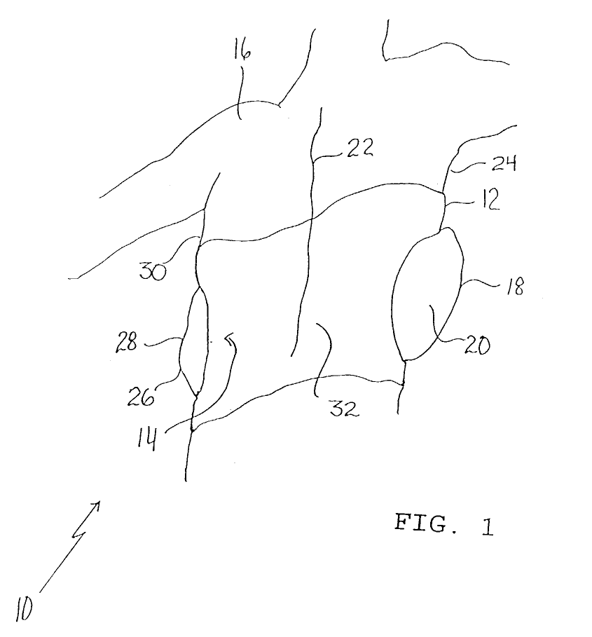

The preferred embodiment, a spinal support for reclining persons generally identified by reference numeral 10, will now be described with-reference to FIGS. 1 through 6.

Structure and Relationship of Parts:

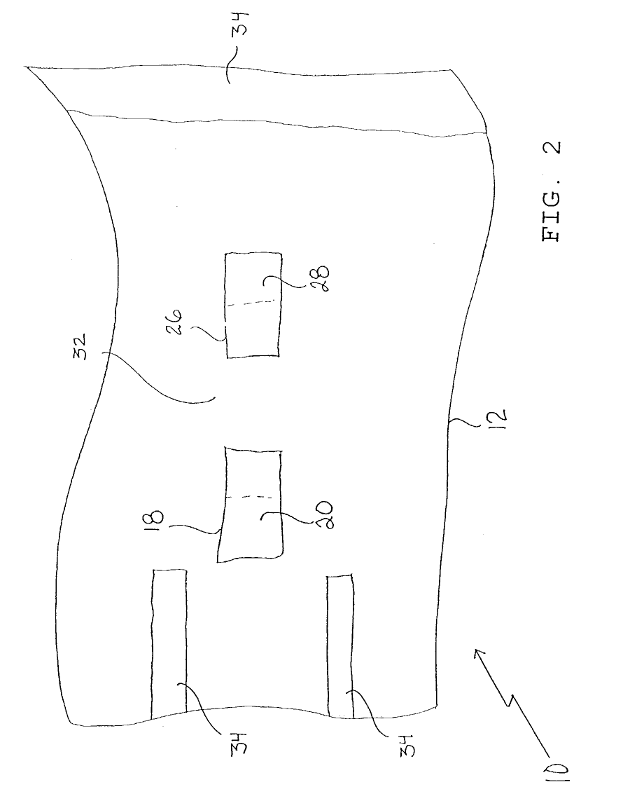

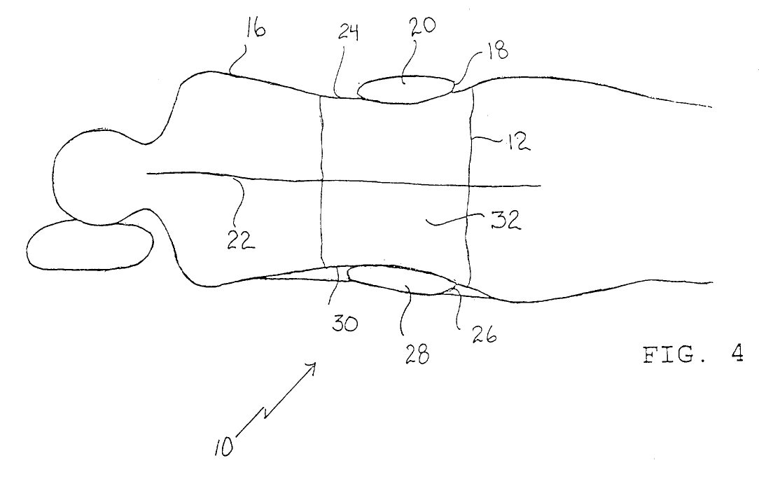

Referring to FIG. 1, spinal support 10 includes a girdle 12 adapted to encircle a waist generally referenced by numeral 14, of a person 16. Referring to FIG. 4, girdle 12 has a right side lumbar support 18 with a symmetrical body 20 adapted to prevent sagging of a lumbar spine 22 of a wearer 16 when lying on his or her right side 24 and a left side lumbar support 26 with a symmetrical body 28 adapted to prevent sagging of lumbar spine 22 of wearer 16 when lying on his or her left side 30. Left side lumbar support 18 is positioned in opposed relation to right side lumbar support 26 with an unpadded connective webbing 30 that extends between right side lumbar support 26 and left side lumbar support 18. Referring to FIG. 2, mating velcro strips 32 are provided for securing spinal support 10 around waist 14 of person 16.

Operation:

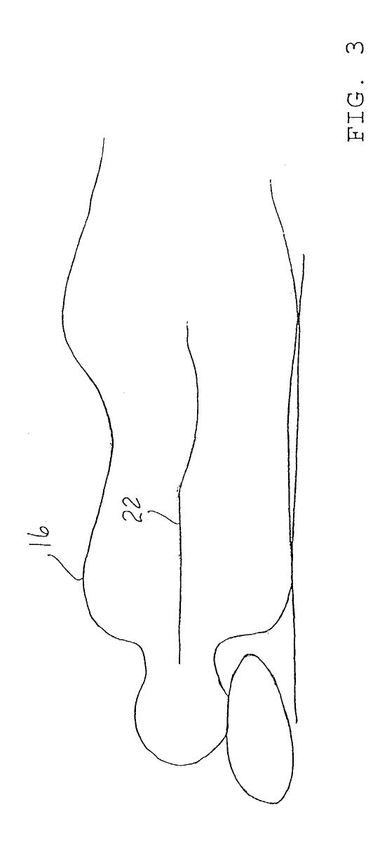

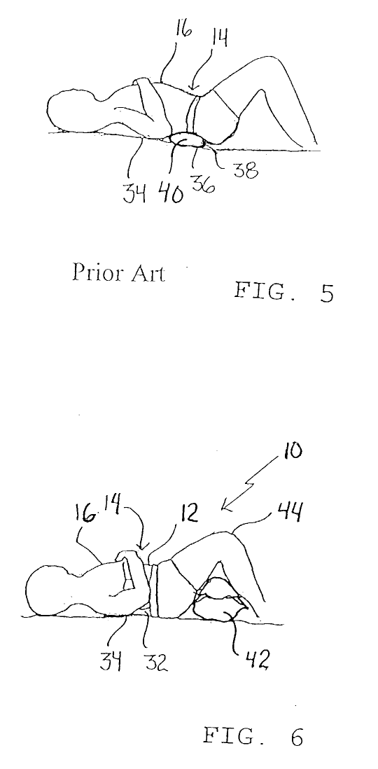

The use and operation of spinal support generally referenced by numeral 10, will now be described with reference to FIGS. 1 through 6. Referring to FIG. 5, there is illustrated person 16 laying on their back 34 with a spinal support 36 from the prior art. As illustrated, prior art spinal support 36 has a padded lumbar support 38 which encircles waist 14 of wearer 16. Padded lumbar support 38 has underpadding 40 that is positioned on back 34 of person 16, and as such tends to further increase the concavity in the curvature of lumbar spine 22 illustrated in FIG. 3, when wearer 16 is laying on their back 34. Referring to FIG. 6, in contrast, spinal support 10 allows for person 16 to lay on their back 34, without further increase to concavity in curvature of lumbar spine 22 illustrated in FIG. 3. Referring to FIG. 2, this is because with spinal support 10, left side lumbar support 18 is positioned in opposed relation to right side lumbar support 26 with an unpadded connective webbing 30 that extends between right side lumbar support 26 and left side lumbar support 18. Referring to FIG. 6, when wearer 16 is laying on their back 34, they are laying on only unpadded connective webbing 30. Wearer 16 is also able to place a stack of pillows 42 under their knees 44 to reduce the lordosis and keep lumbar spine 22 illustrated in FIG. 3, in a more neutral position. The stack of pillows 42 will, of course, only stay in place as long as wearer 16 remains on her back 34.

Left side lumbar support 18 and right side lumbar support 26 can be filled with any suitable material, such as foam, wheat or cotton padding.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A spinal support for reclining persons, comprising:
a girdle adapted to encircle a waist of a person, the girdle having a right side lumbar support with a symmetrical body adapted to prevent sagging of a lumbar spine of a wearer when lying on his or her right side and a left side lumbar support with a symmetrical body adapted to prevent sagging of the lumbar spine of the wearer when lying on his or her left side, the left side lumbar support being positioned in opposed relation to the right side lumbar support with an unpadded connective webbing extending between the right side lumbar support and the left side lumbar support.
